(19) United States
(12) Patent Application Publication
(10) Pub. No.: US 2024/0244695 A1
(43) Pub. Date: Jul. 18, 2024

(54) PORT MAPPING FOR A MULTI-ACCESS DATA CONNECTION

(71) Applicant: Lenovo (Singapore) Pte. Ltd., New Tech Park (SG)

(72) Inventor: Apostolis Salkintzis, Athens (GR)

(21) Appl. No.: 18/580,981

(22) PCT Filed: Aug. 24, 2021
(86) PCT No.: PCT/EP2021/073426

§ 371 Date: Jan. 19, 2024

(30) Foreign Application Priority Data
Jul. 19, 2021 (GR) 20210100485

(51) Int. Cl. H04W 76/16; H04L 69/16

(52) U.S. Cl. CPC H04W 76/16; H04L 69/16

(57) ABSTRACT

Apparatuses, methods, and systems are disclosed for port mapping for a multi-access data connection. One apparatus includes a processor that communicates with a mobile communication network via a non-third generation partnership program access network and via a third generation partnership program access network. The apparatus includes a transmitter that transmits a first message requesting a multi-access data connection with the mobile communication network. The first message includes a first port mapping list, each element in the first port mapping list includes an internal port and a suggested external port, and the first port mapping list is to be applied by a proxy function in the mobile communication network. The apparatus includes a receiver that receives a second message accepting the multi-access data connection. The second message includes a second port mapping list.

The subject matter disclosed herein relates generally to wireless communications and more particularly relates to port mapping for a multi-access data connection.

### BACKGROUND

Certain wireless systems support a feature called multi-access data connections (e.g., multi-access PDU (“MA PDU”) session) between a UE and a UPF, and the policy-controlled routing of the MA PDU Session traffic over two access networks. Essentially, an MA PDU Session is a data connection between a UE and a UPF that can transfer data traffic of a service data flow (“SDF”) (e.g., data traffic of an application) by using both a 3GPP access network (e.g., NR access or E-UTRA access) and a non-3GPP access network (e.g., Wi-Fi or wireline access) by applying multi-access rules (e.g., Access Traffic Steering, Switching and Splitting (“ATSSS”) rules and N4 rules in the UE and in the UPF respectively) and/or port mapping.

### BRIEF SUMMARY

Methods for port mapping for a multi-access data connection are disclosed. Apparatuses and systems also perform the functions of the methods.

One method of a user equipment (“UE”) for port mapping for a multi-access data connection includes communicating with a mobile communication network via a non-third generation partnership program access network and via a third generation partnership program access network. The method includes transmitting a first message requesting a multi-access data connection with the mobile communication network. The first message includes a first port mapping list, each element in the first port mapping list includes an internal port and a suggested external port, and the first port mapping list is to be applied by a proxy function in the mobile communication network. The method includes receiving a second message accepting the multi-access data connection. The second message includes a second port mapping list, each element in the second port mapping list includes the internal port and an assigned external port, and the second port mapping list is applied by the proxy function in the mobile communication network.

One method of a user plane function (“UPF”) for port mapping for a multi-access data connection includes receiving a first message from a session management function in a mobile communication network requesting a multi-access data connection with a user equipment. The first message includes a first port mapping list, each element in the first port mapping list includes an internal port and a suggested external port, and the first port mapping list is to be applied by a proxy function in the user-plane function. The method includes transmitting a second message accepting the multi-access data connection. The second message includes a second port mapping list, each element in the second port mapping list includes the internal port and an assigned external port, and the second port mapping list is applied by the proxy function in the user-plane function.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a diagram illustrating one embodiment of a wireless communication system for port mapping for a multi-access data connection;

FIGS. 2A and 2B are a signal flow diagram illustrating one embodiment of a procedure for port mapping for a multi-access data connection;

FIG. 3 is a signal flow diagram illustrating one embodiment of user-plane communication between a remote host and a local device;

FIG. 4 is a block diagram illustrating one embodiment of a user equipment apparatus for port mapping for a multi-access data connection;

FIG. 5 is a block diagram illustrating one embodiment of a network equipment apparatus for port mapping for a multi-access data connection;

FIG. 6 is a flow chart diagram illustrating one embodiment of a first method for port mapping for a multi-access data connection; and

FIG. 7 is a flow chart diagram illustrating one embodiment of a second method for port mapping for a multi-access data connection.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures, including alternate embodiments of like elements.

Methods, apparatuses, and systems are disclosed for port mapping for a multi-access data connection. In various embodiments, it may be assumed that MPTCP is used between a UE and/or RG and a proxy function in a UPF, it amy be applicable when other multipath protocols, such as the Multipath QUIC (“MPQUIC”) are used.

In certain embodiments, an Access Traffic Steering, Switching and Splitting (“ATSSS”) feature specified in 3GPP specifications enables UEs and/or RGs to make outbound TCP connections through a proxy function in a UPF (called Transport Converter), which can support multipath communication over 3GPP and over non-3GPP accesses.

In some embodiments, a first outbound TCP connection request is generated by a local device operating “behind” a UE and/or RG (in another example, it could be generated by an application inside the UE and/or RG). The first outbound TCP connection request triggers the UE and/or RG to request a second (multipath enabled) TCP connection to the proxy function in the UPF, which further triggers a third TCP connection request to the remote host. After all TCP connections are established, data is exchanged between the local device and the remote host via the proxy function in the UPF and via the UE and/or RG. The data traffic over the second (multipath enabled) TCP connection can be exchanged by simultaneously using a 3GPP access and a non-3GPP access, or by using the most preferred one of these accesses (e.g., the one with the least delay), according with the steering policy provided by the mobile communication network. This multipath communication may improve the communication experience by providing higher bandwidth and/or better reliability.

In various embodiments, support of inbound TCP connections via a proxy function in a UPF is not supported. If the proxy function in the UPF receives an inbound TCP connection request from a remote host towards the UE and/or RG, the proxy function should be able to map the External port in this request (e.g., the TCP destination port) to an Internal port and then initiate a second inbound TCP connection to the UE and/or RG towards this Internal port. The UE and/or RG itself is configured with port forwarding information that maps an Internal port to a local internet protocol (“IP”) address and port. In one example, the UE and/or RG may be configured to forward inbound TCP requests toward the Internal port 1080 to a local service operating in a local device with IP address 192.168.1.100 and on port 9001. This mapping between an Internal port and a local service is depicted as “Internal port 1080-->192.168.1.100/9001”.

In certain embodiments, although a UE and/or RG may be configured (e.g., manually by a user) with port forwarding information, a proxy function in a UPF does not know how to map an External port number to an Internal port number that should be used to reach an intended local service. For example, if the proxy function in the UPF receives an inbound TCP connection request to the External port 8080, it may initiate a second inbound TCP connection request to the UE and/or RG to the Internal port 1080, which may trigger the UE and/or RG to initiate a third inbound TCP connection request to a local service operating in a local device with IP address 192.168.1.100 and on port 9001. In various embodiments, a method may enable a UE and/or RG to configure a proxy function in a UPF with appropriate {Internal port, External port} mappings for supporting inbound TCP connections that may utilize multipath data communication. In certain embodiments, a method for configuring port forwarding information may be used in a proxy function in a UPF.

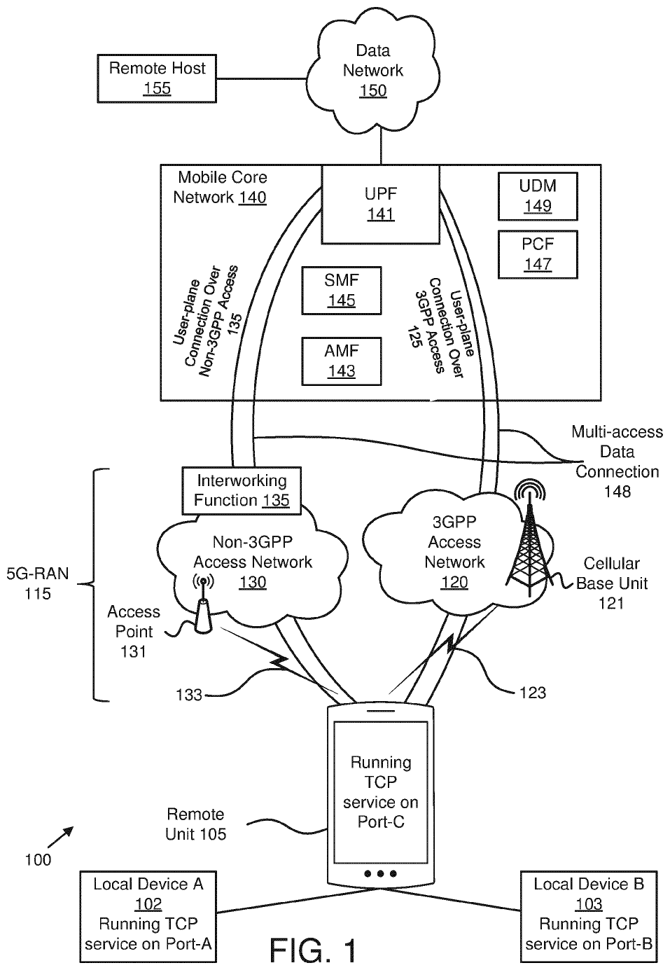

FIG. 1 illustrates an ATSSS-capable Remote Unit (e.g., UE) that communicates with an ATSSS-capable 5G mobile network that is part of a 5G-RAN and a 5G mobile core network. The 5G-RAN supports a 3GPP access network and a non-3GPP access network. Communication between the UE and the UPF, au be multi-access communication, using data transmissions over both the 3GPP access network and the non-3GPP access network. The multi-access communication may be enabled by a Multi-path TCP (“MPTCP”) protocol running at the UE and at the UPF. In some embodiments, a MPTCP protocol may run between the UE and a network function outside the UPF (e.g., in a ATSSS proxy function). The UPF or the ATSSS proxy function may implement a Transport Converter which is a special type of proxy suitable to support MPTCP connections.

The UE could be a regular 5G smartphone or a 5G Residential Gateway (“5G-RG”). It may be connected to several local devices, which access the 5G mobile network via the UE. In one example, a local device could be a laptop device in an enterprise network, which can originate outbound connections to a remote host via the UE and the 5G mobile network. In another example, a local device may be a printer in a residential network, which can terminate inbound connections from a remote host via the UE and the 5G mobile network. In yet another example, the UE itself may implement a local service (e.g., a web server), which can terminate inbound connections. To enable such inbound connections, the Transport Converter proxy in the UPF (or in the ATSSS proxy) may be configured so that it accepts the inbound connections and forwards these connections to the UE by using the MPTCP protocol. Subsequently, the UE forwards the inbound connections either to an external device (e.g., a printer), or to an internal service (e.g., an internal web server). Various embodiments found herein include enhancements to ATSSS procedures which enable the support of such inbound connections.

FIG. 1 depicts a wireless communication system 100 for port mapping for a multi-access data connection, according to embodiments of the disclosure. In one embodiment, the wireless communication system 100 includes a local device A 102 (e.g., running a transmission control protocol (“TCP”) service on Port-A), a local device B 103 (e.g., running a TCP service on Port-B), at least one remote unit 105 (running a TCP service on Port-C), a fifth-generation radio access network (“5G-RAN”) 115, and a mobile core network 140. The 5G-RAN 115 and the mobile core network 140 form a mobile communication network. The 5G-RAN 115 may be composed of a 3GPP access network 120 containing at least one cellular base unit 121 and/or a non-3GPP access network 130 containing at least one access point 131. The remote unit communicates with the 3GPP access network 120 using 3GPP communication links 123 and communicates with the non-3GPP access network 130 using non-3GPP communication links 133. Even though a specific number of local units 102, 103, remote units 105, 3GPP access networks 120, cellular base units 121, 3GPP communication links 123, non-3GPP access networks 130, access points 131, non-3GPP communication links 133, and mobile core networks 140 are depicted in FIG. 1, one of skill in the art will recognize that any number of remote units 105, 3GPP access networks 120, cellular base units 121, 3GPP communication links 123, non-3GPP access networks 130, access points 131, non-3GPP communication links 133, and mobile core networks 140 may be included in the wireless communication system 100.

In one implementation, the wireless communication system 100 is compliant with the 5G system specified in the 3GPP specifications. More generally, however, the wireless communication system 100 may implement some other open or proprietary communication network, for example, long term evolution (“LTE”) or worldwide interoperability for microwave access (“WiMAX”), among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the cellular base units 121 in the 3GPP access network 120 via uplink (“UL”) and downlink (“DL”) communication signals. Furthermore, the UL and DL communication signals may be carried over the 3GPP communication links 123. Similarly, the remote units 105 may communicate with one or more access points 131 in the non-3GPP access network(s) 130 via UL and DL communication signals carried over the non-3GPP communication links 133. Here, the access networks 120 and 130 are intermediate networks that provide the remote units 105 with access to the mobile core network 140.

In some embodiments, the remote units 105 communicate with a remote host 155 via a network connection with the mobile core network 140. For example, an application in a remote unit 105 (e.g., web browser, media client, telephone/VoIP application) may trigger the remote unit 105 to establish a PDU session (or other data connection (e.g., multi-access data connection 148)) with the mobile core network 140 using the 5G-RAN 115 (e.g., a 3GPP access network 120 and/or a non-3GPP access network 130). The mobile core network 140 then relays traffic between the remote unit 105 and the data network 150 (e.g., remote host 155) using the PDU session. Note that the remote unit 105 may establish one or more PDU sessions (or other data connections) with the mobile core network 140. As such, the remote unit 105 may have at least one PDU session for communicating with the data network 150. The remote unit 105 may establish additional PDU sessions for communicating with other data network and/or other remote hosts.

Moreover, the remote unit 105 may establish a multi-access PDU session (i.e., multi-access data connection) with the mobile core network 140 whereby traffic of the multi-access PDU session is steered over one or both of the 3GPP access network 120 and/or a non-3GPP access network 130, according to steering rules. Additionally, a user-plane connection over 3GPP access 125 may be established over the 3GPP access network 120 for transferring traffic of the multi-access PDU session. Similarly, a user-plane connection over non-3GPP access 135 may be established over the non-3GPP access network 130 for handling traffic of the multi-access PDU session. Accordingly, the remote unit 105 may be configured with a TCP service running on Port-C.

The cellular base units 121 may be distributed over a geographic region. In certain embodiments, a cellular base unit 121 may also be referred to as an access terminal, a base, a base station, a Node-B, an eNB, a gNB, a Home Node-B, a relay node, a device, or by any other terminology used in the art. The cellular base units 121 are generally part of a radio access network (“RAN”), such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a serving area, for example, a cell or a cell sector, via a 3GPP communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the 3GPP communication links 123. The 3GPP communication links 123 may be any suitable carrier in licensed or unlicensed radio spectrum. The 3GPP communication links 123 facilitate communication between one or more of the remote units 105 and/or one or more of the cellular base units 121.

The non-3GPP access networks 130 may be distributed over a geographic region. Each non-3GPP access network 130 may serve a number of remote units 105 with a serving area. An access point 131 in a non-3GPP access network 130 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 131 may communicate using unlicensed radio spectrum. The mobile core network 140 may provide services to a remote unit 105 via the non-3GPP access networks 130, as described in greater detail herein.

In some embodiments, a non-3GPP access network 130 connects to the mobile core network 140 via an interworking function 135. The interworking function 135 provides interworking between the remote unit 105 and the mobile core network 140. In some embodiments, the interworking function 135 is a Non-3GPP Interworking Function (“N3IWF”) and, in other embodiments, it is a Trusted Non-3GPP Gateway Function (“TNGF”). The N3IWF supports the connection of “untrusted” non-3GPP access networks to the mobile core network (e.g., 5GC), whereas the TNGF supports the connection of “trusted” non-3GPP access networks to the mobile core network. The interworking function 135 supports connectivity to the mobile core network 140 via the “N2” and “N3” interfaces, and it relays “N1” signaling between the remote unit 105 and the AMF 143. Both the 3GPP access network 120 and the interworking function 135 communicate with the AMF 143 using a “N2” interface. The interworking function 135 also communicates with the UPF 141 using a “N3” interface.

In certain embodiments, a non-3GPP access network 130 may be controlled by an operator of the mobile core network 140 and may have direct access to the mobile core network 140. Such a non-3GPP AN deployment is referred to as a “trusted non-3GPP access network.” A non-3GPP access network 130 is considered as “trusted” when it is operated by the 3GPP operator, or a trusted partner, and supports certain security features, such as strong air-interface encryption. In contrast, a non-3GPP AN deployment that is not controlled by an operator (or trusted partner) of the mobile core network 140, does not have direct access to the mobile core network 140, or does not support the certain security features is referred to as a “non-trusted” non-3GPP access network.

In one embodiment, the mobile core network 140 is a 5G core (“5GC”) or the evolved packet core (“EPC”), which may be coupled to a data network (e.g., the data network 150, such as the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes at least a UPF 141 that serves the 3GPP access network 120 and the non-3GPP access network 130. Note that in certain embodiments, the mobile core network may contain one or more intermediate UPFs, for example a first intermediate UPF that serves the non-3GPP access network 130 and the second intermediate UPF that serves the 3GPP access network 120. In such embodiments, the UPF 141 would be an anchor UPF receiving UP traffic of both intermediate UPFs.

The mobile core network 140 also includes multiple control plane functions including, but not limited to, an Access and Mobility Management Function (“AMF”) 143 that serves both the 3GPP access network 120 and the non-3GPP access network 130, a Session Management Function (“SMF”) 145, a Policy Control Function (“PCF”) 147, and a Unified Data Management function (“UDM”) 149. In certain embodiments, the mobile core network 140 may also include an Authentication Server Function (“AUSF”), a Network Repository Function (“NRF”) (used by the various NFs to discover and communicate with each other over application programming interfaces (“APIs”)), or other NFs defined for the 5GC. In various embodiments, the mobile core network 140 may include a PMF (not shown) to assist the remote unit 105 and/or the UPF 141 in taking performance measurements over the two accesses, including latency measurements. In one embodiment, the PMF may be co-located with the UPF 141.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. Each slice may be identified using a single network slice selection assistance information (“S-NSSAI”). In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 is an EPC, the depicted network functions may be replaced with appropriate EPC entities, such as a mobility management entity (“MME”), S-GW, P-GW, home subscriber server (“HSS”), and the like.

As depicted, a remote unit 105 (e.g., a UE) may connect to the mobile core network (e.g., to a 5G mobile communication network) via two types of accesses: (1) via 3GPP access network 120 and (2) via a non-3GPP access network 130. The first type of access (e.g., 3GPP access network 120) uses a 3GPP-defined type of wireless communication (e.g., next generation radio access network (“NG-RAN”)) and the second type of access (e.g., non-3GPP access network 130) uses a non-3GPP-defined type of wireless communication (e.g., WLAN). The 5G-RAN 115 refers to any type of 5G access network that can provide access to the mobile core network 140, including the 3GPP access network 120 and the non-3GPP access network 130.

To determine port mapping, the remote unit 105 may perform functions to transmit a mapping request and receive a mapping response.

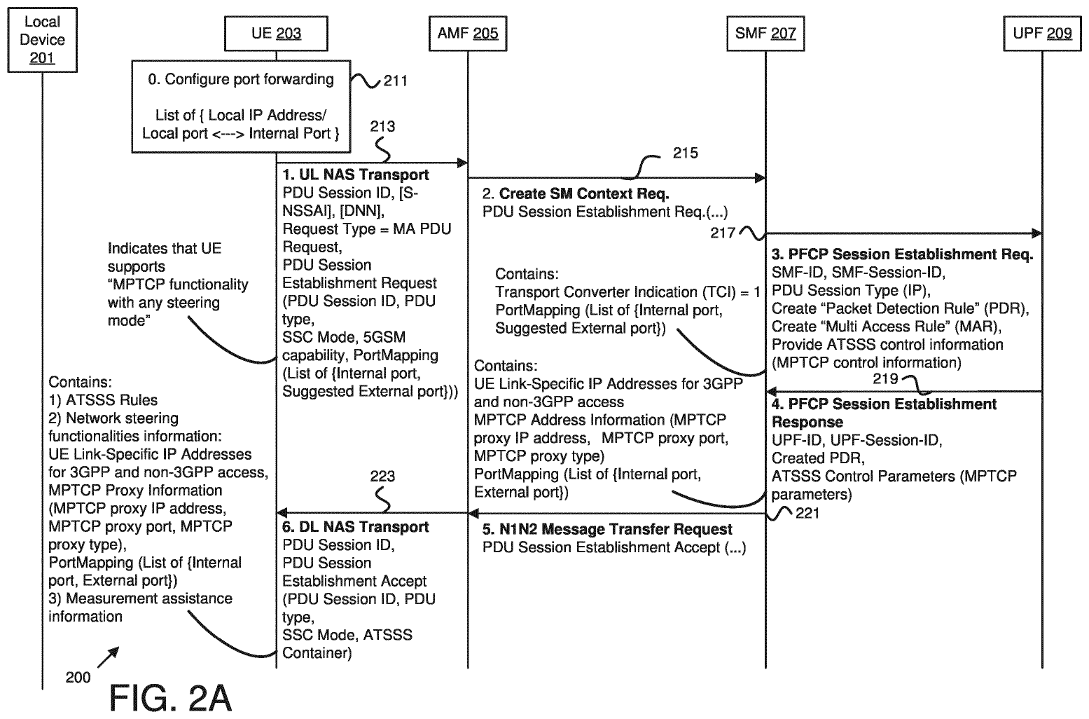

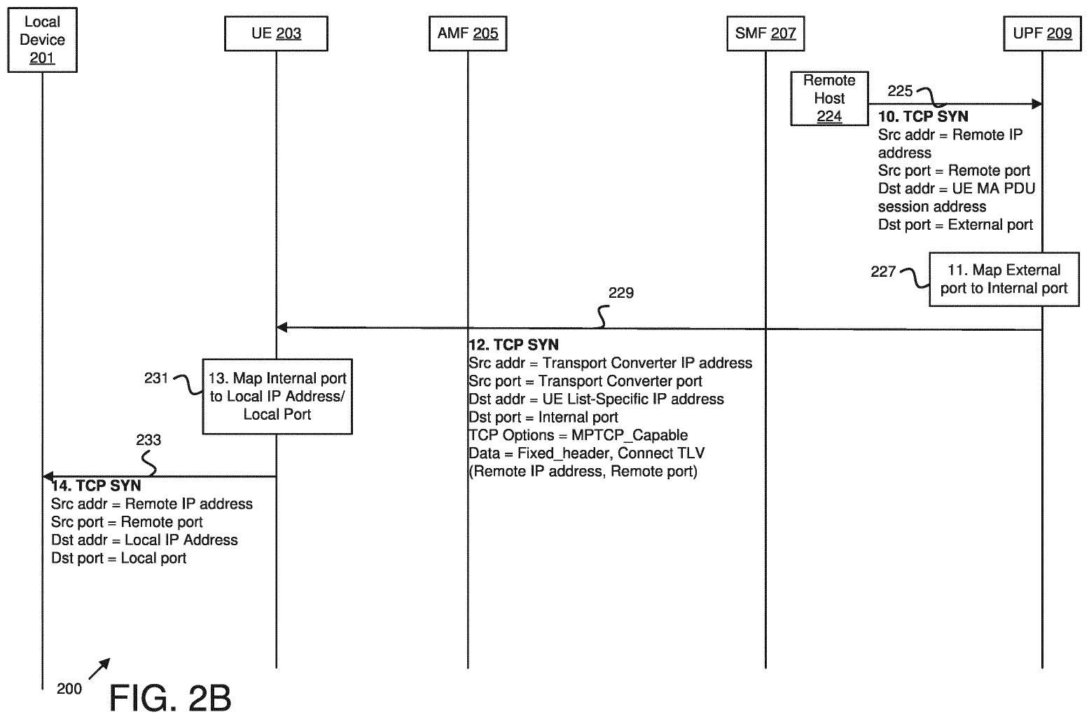

FIGS. 2A and 2B depict a procedure 200 for port mapping for a multi-access data connection, according to embodiments of the disclosure. The procedure 200 involves a local device 201 (e.g., a printer), a UE 203 (e.g., one embodiment of the remote unit 105, a residential gateway (“RG”)), an AMF 205 (e.g., one embodiment of the AMF 143), an SMF 207 (e.g., one embodiment of the SMF 145), and a UPF 209 (e.g., or ATSSS proxy).

The local device 201 operates “behind” the UE 203 and hosts a TCP service which may be reachable by a remote host operating in a data network (e.g., in the Internet).

Referring to FIG. 2A, the procedure 200 begins at Step 0 when, the UE 203 may be configured 211 to support port forwarding so that services deployed in local devices or within the UE 203 can be reached from a remote host (e.g., from an Internet device). For example, if a local device 201 has IP address 192.168.1.200 and supports a printing service on TCP port 9100, the UE 203 may be configured to forward inbound TCP connection requests arriving on port 1080 to address 192.168.1.200 and port 9100. This corresponds to the following port binding: Internal port 1080<---->Local address 192.168.1.200, Local port 9100. The UE 203 may be configured with several such port bindings, each one for a separate service.

At Step 1, the UE 203 initiates 213 the establishment of a Multi-Access (“MA”) PDU Session so that it can support multi-access communication with the UPF 209. FIG. 2A, the shows only some of the messages (e.g., Steps 1-6) exchanged for establishing the MA PDU Session.

The UE 203 sends an UL non-access stratum (“NAS”) transport message including a Request Type=MA PDU Request and a PDU Session Establishment Request message. This message indicates that the UE supports the MPTCP functionality. For enabling inbound connections, the PDU Session Establishment Request message also contains a new PortMapping information element (“IE”), which contains a list of {Internal port, Suggested External port} mappings. For example, to support the printing service in the local device, the PortMapping IE may contain the port mapping: {Internal port=1080, Suggested External port-9100}. This indicates that the Transport Converter proxy in the UPF 209 (or in the ATSSS proxy), should accept an inbound TCP connection on port 9100 and should initiate an inbound MPTCP connection to the UE 203 on port 1080. Based on the configured port bindings in the UE 203, this inbound MPTCP connection will trigger a TCP connection to the local address 192.168.1.200 and to the local port 9100 (e.g., to the printing service in the local device).

It should be noted that the Suggested External port is only an external port suggested by the UE 203. The Transport Converter proxy in the UPF 209 may accept this suggestion or may decide to use another external port (e.g., if the suggested external port is already used).

At Step 2, the AMF 205 receives the UL NAS Transport request and forwards 215 the embedded PDU Session Establishment Request message to the SMF 207.

At Step 3, the SMF 207 selects a UPF 209 that supports MPTCP (thus, it also implements a Transport Converter) and initiates 217 a Packet Forwarding Control Protocol (“PFCP”) session with the UPF 209, by sending a PFCP Session Establishment Request message to the UPF 209. This message contains the PortMapping IE received in Step 2. In one example, the PortMapping IE is contained in the “MPTCP control information” element that is part of the “Provide ATSSS control information” IE.

The Transport Converter in the UPF 209 (or ATSSS proxy) receives the PortMapping IE and decides if each Suggested External port can be accepted or not. If it cannot be accepted (e.g., because it cannot be locally assigned), then the Transport Converter decides an alternative External port.

The PFCP Session Establishment Request message also contains other parameters which are needed by the UPF 209 to operate as a packet forwarding function in the user plane.

At Step 4, the UPF 209 responds 219 to the SMF 207 by sending a PFCP Session Establishment Response message that contains a PortMapping IE including the list of {Internal port, External port} pairs accepted to be applied by the Transport Converter.

At Step 5, the SMF 207 creates 221 a PDU Session Establishment Accept message and sends this message to the AMF 205, embedded in a NIN2 Message Transfer Request.

At Step 6, the AMF 205 forwards 223 the PDU Session Establishment Accept message to the UE 203, embedded in a DL NAS Transport message. The PDU Session Establishment Accept message includes the PortMapping IE provided by the UPF 209 in Step 4, which includes the list of {Internal port, External port} pairs accepted to be applied by the Transport Converter.

It should be noted that the UE 203 requires only to know the Internal port that is associated with each inbound service. However, the External port associated with each inbound service is also provided so that it can be advertised to external service consumers. For example, if a remote host (external service consumer) wants to connect to a printing service provided by the UE 203 (or by a local device 201 behind the UE 203), the remote host must know the UE 203 external IP address and also the external port associated with the printing service.

After this step, the MA PDU Session is established and the UPF 209 may accept inbound connection requests to every external port included in the PortMapping IE provided in Step 4. The following steps illustrate how a remote host can establish a TCP connection to a service hosted in a local device (or inside the UE 203).

Turning to FIG. 2B, at Step 10, a remote host 224 sends 225 a TCP connection request (“TCP SYN”) with a destination IP address set to the UE's 203 IP address (assigned during the MA PDU Session establishment) and with destination TCP port set to the external port associated with the requested service (e.g., with the printing service). The source IP address and the source port contain the remote host's IP address and remote host's port, respectively.

At Step 11, the Transport Converter in the UPF 209 proxy maps 227 the received external port to an internal port based on the list of {Internal port, External port} mappings configured during the MA PDU session establishment procedure. If the Transport Converter cannot map the external port to an internal port, then the Transport Converter may reject or may silently ignore the TCP SYN packet.

At Step 12, the Transport Converter in the UPF 209 initiates 229 an inbound MPTCP connection to the UE 203 by sending a TCP SYN packet to the UE 203, either via 3GPP access or via non-3GPP access. The TCP SYN packet contains the UE's 203 link-specific IP address as a destination IP address, and the internal port as a destination port. It also contains the MPTCP_Capable TCP option and a Connect TLV (Type-Length-Value) element containing the remote host IP address and the remote port received in Step 10. The Connect TL V is one of the TLVs supported by the Transport Converter protocol.

At Step 13, the UE 203 maps 231 the received internal port to a local IP address and/or local port based on the port bindings configured in Step 0. This local IP address and/or local port hosts the service that the remote host attempts to connect to.

At Step 14, the UE 203 initiates 233 another TCP connection to the local IP address and/or local port by sending another TCP SYN packet. This TCP SYN packet also contains the remote host IP address and/or remote port that were received in Step 10. This way, the local device 201 that terminates the TCP SYN knows the IP address and port of the remote host, which attempts to access the local service.

After this step, the local device responds with a TCP SYN+acknowledgment (“ACK”) packet (e.g., if the service request is accepted), and additional TCP packets are exchanged until all TCP connections are established and communication between the remote host and the service in the local device is enabled.

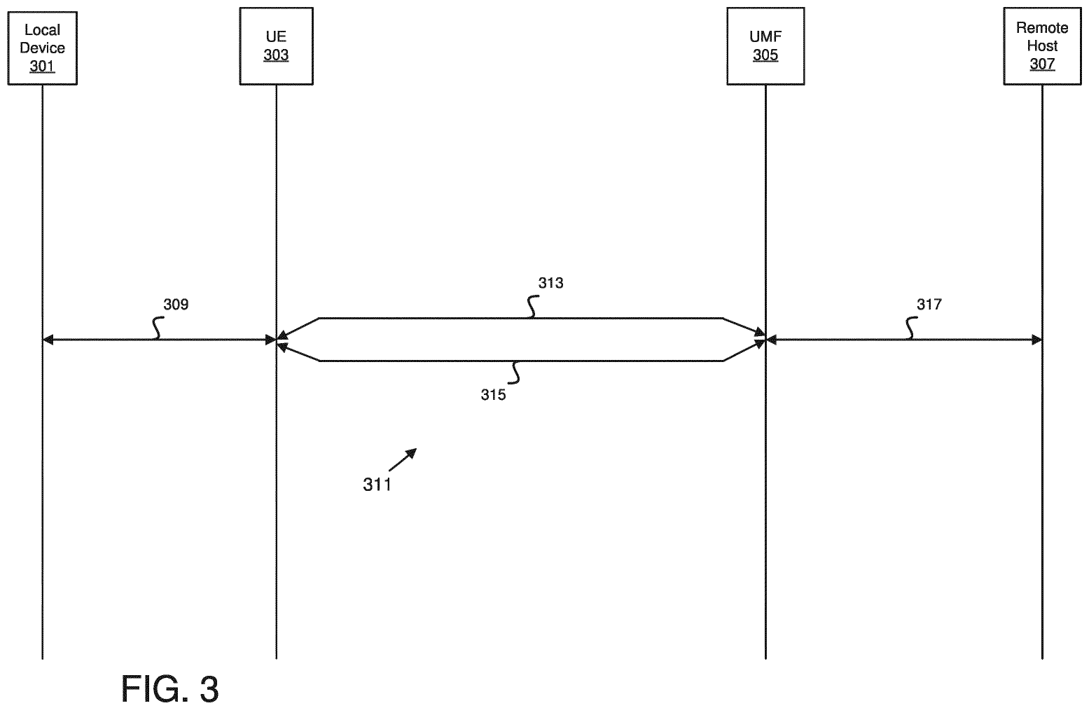

FIG. 3 shows that communication between the remote host and the service in the local device involves three distinct TCP connections: 1) a local TCP connection between the local device and a UE and/or RG; 2) an MPTCP connection between the UE and/or RG and the Transport Converter in a UPF and/or ATSSS proxy, which can simultaneously use communication over third generation partnership program (“3GPP”) access and non-3GPP access; and 3) a remote TCP connection between the Transport Converter in the UPF and/or ATSSS proxy and the remote host.

It should be noted that that the local TCP connection and the remote TCP connection could also be MPTCP connections if the local device and the remote host also supported MPTCP.

FIG. 3 is a signal flow diagram illustrating one embodiment of user-plane communication between a remote host and a local device. The communications include messages transmitted between a local device 301, a UE 303 (and/or RG), an UPF 305 (and/or ATSSS proxy), and a remote host 307. A local TCP connection 309 is used for communications between the local device 301 and the UE 303, and a multipath TCP connection 311 is used for communications between the UE 303 and the UPF 305. Specifically, the multipath TCP connection 311 includes a 3GPP access 313 and a non-3GPP access 315. Further, a remote TCP connection 317 is used for communications between the UPF 305 and the remote host 307.

If the UE 303 wants to update the list of {Internal port, External port} mappings in the Transport Converter (e.g., because a new local service is instantiated and should be reachable from remote hosts), the UE 303 initiates a MA PDU Session Modification procedure, which is essentially the same as Steps 1-6 in FIG. 2A. The main difference is that the UE 303 sends a PDU Session Modification Request (e.g., instead of a PDU Session Establishment Request) including a new PortMapping IE.

To remove an existing port mapping, the UE 303 may provide an {Internal port, External port=0} pair. The value 0 (or any other reserved value) for the External port, indicates that the associated port mapping should be deleted.

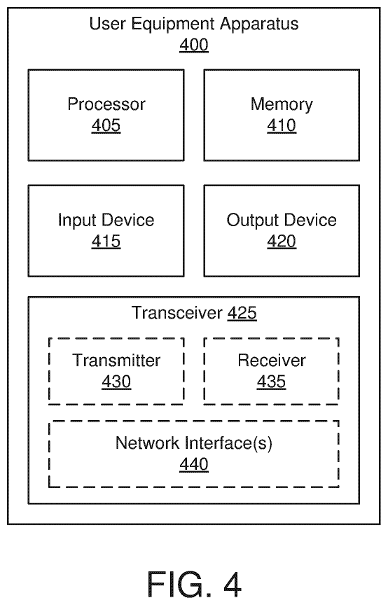

FIG. 4 depicts one embodiment of a user equipment apparatus 400 that may be used for port mapping for a multi-access data connection, according to embodiments of the disclosure. The user equipment apparatus 400 may be one embodiment of the remote unit 105 and/or the UE 203. Furthermore, the user equipment apparatus 400 may include a processor 405, a memory 410, an input device 415, an output device 420, a transceiver 425. In some embodiments, the input device 415 and the output device 420 are combined into a single device, such as a touch screen. In certain embodiments, the user equipment apparatus 400 does not include any input device 415 and/or output device 420.

As depicted, the transceiver 425 includes at least one transmitter 430 and at least one receiver 435. Here, the transceiver 425 communicates with a mobile core network (e.g., a 5GC) via one or more access networks. Additionally, the transceiver 425 may support at least one network interface 440. Here, the at least one network interface 440 facilitates communication with an eNB or gNB (e.g., using the “Uu” interface). Additionally, the at least one network interface 440 may include an interface used for communications with an AMF, an SMF, and/or a UPF.

In some embodiments, the transceiver 425 comprises a first transceiver that communicates with a mobile communication network via a first access network and a second transceiver that communicates with the mobile communication network via a second access network. In other embodiments, the transceiver 425 comprises a first functionality (e.g., modem) for communicating with the mobile communication network via the first access network and a second functionality (e.g., modem) for communicating with the mobile communication network via the second access network.

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425.

In various embodiments, the processor 405 communicates with a mobile communication network via a non-third generation partnership program access network and via a third generation partnership program access network.

The transmitter 430 transmits a first message requesting a multi-access data connection with the mobile communication network. The first message includes a first port mapping list, each element in the first port mapping list includes an internal port and a suggested external port, and the first port mapping list is to be applied by a proxy function in the mobile communication network.

The receiver 435 receives a second message accepting the multi-access data connection. The second message includes a second port mapping list, each element in the second port mapping list includes the internal port and an assigned external port, and the second port mapping list is applied by the proxy function in the mobile communication network.

The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media. In some embodiments, the memory 410 stores data relating to port mapping for a multi-access data connection, for example storing access network information (“ANI”), IP addresses, and the like. In certain embodiments, the memory 410 also stores program code and related data, such as an operating system (“OS”) or other controller algorithms operating on the user equipment apparatus 400 and one or more software applications.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, may include any known electronically controllable display or display device. The output device 420 may be designed to output visual, audible, and/or haptic signals. In some embodiments, the output device 420 includes an electronic display capable of outputting visual data to a user. For example, the output device 420 may include, but is not limited to, a liquid crystal display (“LCD”) display, an LED display, an organic light emitting diode (“OLED”) display, a projector, or similar display device capable of outputting images, text, or the like to a user. As another, non-limiting, example, the output device 420 may include a wearable display such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all or portions of the output device 420 may be integrated with the input device 415. For example, the input device 415 and output device 420 may form a touchscreen or similar touch-sensitive display. In other embodiments, all or portions of the output device 420 may be located near the input device 415.

As discussed above, the transceiver 425 communicates with one or more network functions of a mobile communication network via one or more access networks. The transceiver 425 operates under the control of the processor 405 to transmit messages, data, and other signals and also to receive messages, data, and other signals. For example, the processor 405 may selectively activate the transceiver (or portions thereof) at particular times in order to send and receive messages.

The transceiver 425 may include one or more transmitters 430 and one or more receivers 435. Although only one transmitter 430 and one receiver 435 are illustrated, the user equipment apparatus 400 may have any suitable number of transmitters 430 and receivers 435. Further, the transmitter(s) 430 and the receiver(s) 435 may be any suitable type of transmitters and receivers. In one embodiment, the transceiver 425 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

In various embodiments, one or more transmitters 430 and/or one or more receivers 435 may be implemented and/or integrated into a single hardware component, such as a multi-transceiver chip, a system-on-a-chip, an application-specific integrated circuit (“ASIC”), or other type of hardware component. In certain embodiments, one or more transmitters 430 and/or one or more receivers 435 may be implemented and/or integrated into a multi-chip module. In some embodiments, other components such as the network interface 440 or other hardware components/circuits may be integrated with any number of transmitters 430 and/or receivers 435 into a single chip. In such embodiment, the transmitters 430 and receivers 435 may be logically configured as a transceiver 425 that uses one more common control signals or as modular transmitters 430 and receivers 435 implemented in the same hardware chip or in a multi-chip module.

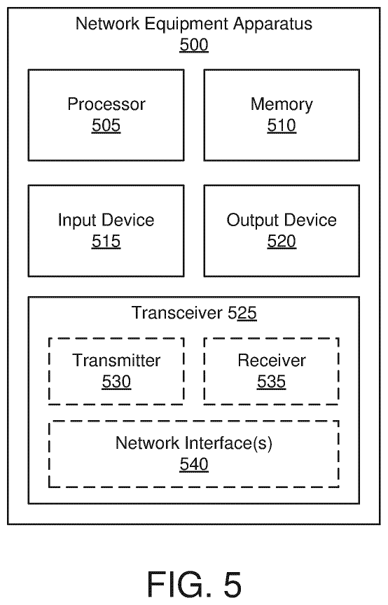

FIG. 5 depicts one embodiment of a network equipment apparatus 500 that may be used for port mapping for a multi-access data connection, according to embodiments of the disclosure. In some embodiments, the network equipment apparatus 500 may implement a UPF. In other embodiments, the network equipment apparatus 500 may implement other network functions. Furthermore, network equipment apparatus 500 may include a processor 505, a memory 510, an input device 515, an output device 520, a transceiver 525. In some embodiments, the input device 515 and the output device 520 are combined into a single device, such as a touch screen. In certain embodiments, the network equipment apparatus 500 does not include any input device 515 and/or output device 520.

As depicted, the transceiver 525 includes at least one transmitter 530 and at least one receiver 535. Here, the transceiver 525 communicates with one or more remote units 105. Additionally, the transceiver 525 may support at least one network interface 540. In some embodiments, the transceiver 525 supports a first interface for communicating with a RAN node, a second interface for communicating with one or more network functions in a mobile core network (e.g., a 5GC) and a third interface for communicating with a remote unit (e.g., UE).

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the first transceiver 525.

In various embodiments, the network equipment apparatus 500 operates as a UPF. In such embodiments, the receiver 535 receives a first message from a session management function in a mobile communication network requesting a multi-access data connection with a user equipment. The first message includes a first port mapping list, each element in the first port mapping list includes an internal port and a suggested external port, and the first port mapping list is to be applied by a proxy function in the user-plane function.

The transmitter 530 transmits a second message accepting the multi-access data connection. The second message includes a second port mapping list, each element in the second port mapping list includes the internal port and an assigned external port, and the second port mapping list is applied by the proxy function in the user-plane function.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media. In some embodiments, the memory 510 stores data relating to port mapping for a multi-access data connection, for example storing ANI, IP addresses, UE contexts, and the like. In certain embodiments, the memory 510 also stores program code and related data, such as an operating system (“OS”) or other controller algorithms operating on the network equipment apparatus 500 and one or more software applications.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, may include any known electronically controllable display or display device. The output device 520 may be designed to output visual, audible, and/or haptic signals. In some embodiments, the output device 520 includes an electronic display capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, all or portions of the output device 520 may be located near the input device 515.

As discussed above, the transceiver 525 may communicate with one or more remote units and/or with one or more interworking functions that provide access to one or more PLMNs. The transceiver 525 may also communicate with one or more network functions (e.g., in the mobile core network 140). The transceiver 525 operates under the control of the processor 505 to transmit messages, data, and other signals and also to receive messages, data, and other signals. For example, the processor 505 may selectively activate the transceiver (or portions thereof) at particular times in order to send and receive messages.

The transceiver 525 may include one or more transmitters 530 and one or more receivers 535. In certain embodiments, the one or more transmitters 530 and/or the one or more receivers 535 may share transceiver hardware and/or circuitry. For example, the one or more transmitters 530 and/or the one or more receivers 535 may share antenna(s), antenna tuner(s), amplifier(s), filter(s), oscillator(s), mixer(s), modulator/demodulator(s), power supply, and the like. In one embodiment, the transceiver 525 implements multiple logical transceivers using different communication protocols or protocol stacks, while using common physical hardware.

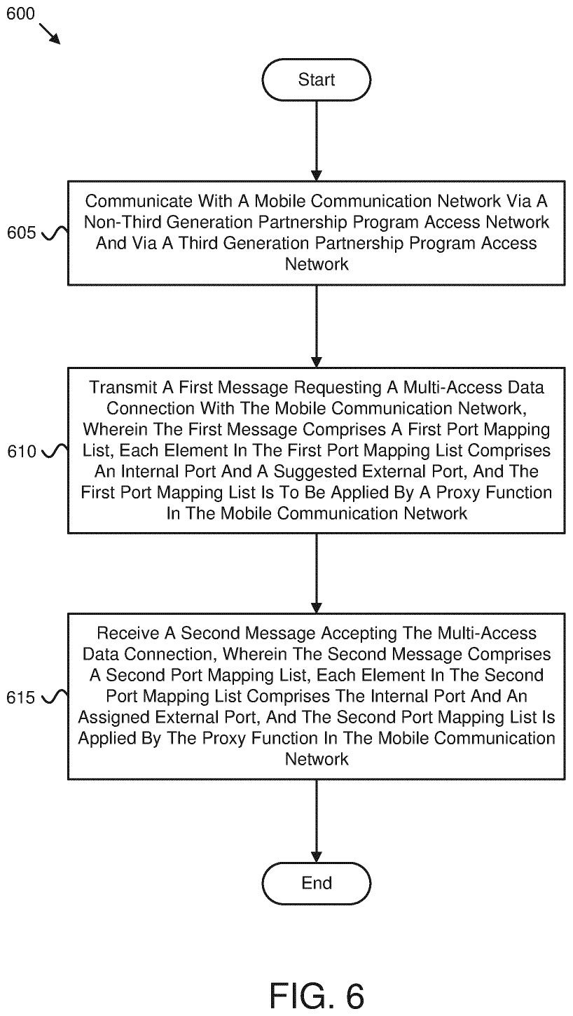

FIG. 6 depicts a method 600 for port mapping for a multi-access data connection, according to embodiments of the disclosure. In some embodiments, the method 600 is performed by a UE, such as the remote unit 105, the UE 203 and/or the user equipment apparatus 400. In certain embodiments, the method 600 may be performed by a processor executing program code, for example, a microcontroller, a microprocessor, a CPU, a GPU, an auxiliary processing unit, a FPGA, or the like.

The method 600 begins and communicates 605, using a first interface of a user equipment, with a mobile communication network via a non-third generation partnership program access network and via a third generation partnership program access network. The method 600 includes transmitting 610 a first message requesting a multi-access data connection with the mobile communication network. The first message includes a first port mapping list, each element in the first port mapping list includes an internal port and a suggested external port, and the first port mapping list is to be applied by a proxy function in the mobile communication network. The method 600 includes receiving 615 a second message accepting the multi-access data connection. The second message includes a second port mapping list, each element in the second port mapping list includes the internal port and an assigned external port, and the second port mapping list is applied by the proxy function in the mobile communication network. The method 600 ends.

In certain embodiments, the method 600 further comprises receiving a connection request from the proxy function for a first internal port. In some embodiments, the method 600 further comprises initiating a connection with a local service after receiving the connection request, wherein the local service is determined based on the first internal port. In various embodiments, the connection with the local service contains an internet protocol address and a port number of a remote host.

In one embodiment, the connection request from the proxy function comprises a transmission control protocol connection request packet containing a multi-path transmission control protocol capable option and includes an internet protocol address and a port number of a remote host. In certain embodiments, the first port mapping list is included in the first message for enabling inbound connections to the user equipment via the proxy function. In some embodiments, the first port mapping list is included in the first message in response to the user equipment being configured to provide port forwarding.

In various embodiments, the proxy function is implemented in a user-plane function of the mobile communication network, and the user-plane function terminates the multi-access data connection. In one embodiment, the first message comprises a protocol data unit session establishment request message, and the first port mapping list is contained in the protocol data unit session establishment request message. In certain embodiments, the second message comprises a protocol data unit session establishment accept message, and the second port mapping list is contained in a protocol data unit session establishment request message.

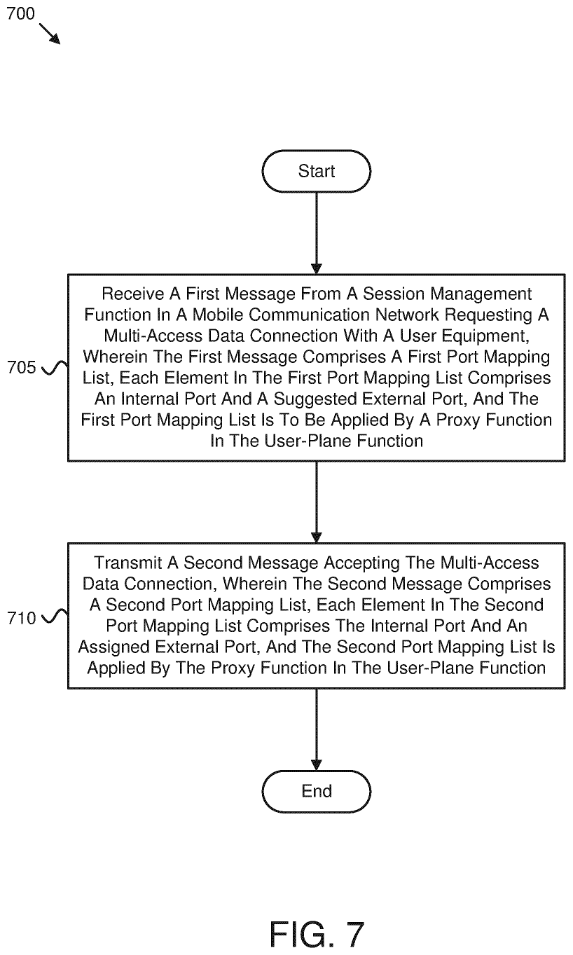

FIG. 7 depicts a method 700 for port mapping for a multi-access data connection, according to embodiments of the disclosure. In some embodiments, the method 700 is performed by a UPF, such as the UPF 141, the UPF 209, and/or the network apparatus 500. In certain embodiments, the method 700 may be performed by a processor executing program code, for example, a microcontroller, a microprocessor, a CPU, a GPU, an auxiliary processing unit, a FPGA, or the like.

The method 700 begins and receives 705, using an interface, a first message from a session management function in a mobile communication network requesting a multi-access data connection with a user equipment. The first message includes a first port mapping list, each element in the first port mapping list includes an internal port and a suggested external port, and the first port mapping list is to be applied by a proxy function in the user-plane function. The method 700 includes transmitting 710 a second message accepting the multi-access data connection. The second message includes a second port mapping list, each element in the second port mapping list includes the internal port and an assigned external port, and the second port mapping list is applied by the proxy function in the user-plane function. In various embodiments, the proxy function is outside of the user-plane function. The method 700 ends.

In certain embodiments, the method 700 further comprises receiving a connection request from a remote host, wherein the connection request is for an address of a user equipment and a first external port. In some embodiments, the method 700 further comprises using the second port mapping list to derive a first internal port mapped to the first external port. In various embodiments, the method further comprises transmitting a connection request to the user equipment for the first internal port.

In one embodiment, the connection request comprises a transmission control protocol connection request packet containing a multi-path transmission control protocol capable option and includes an internet protocol address and a port number of the remote host. In certain embodiments, the first port mapping list is included in the first message for enabling inbound connections to the user equipment via the user-plane function. In some embodiments, the first port mapping list is included in the first message in response to the user equipment being configured to provide port forwarding.

In various embodiments, the first message is a packet forwarding control protocol session establishment request message, wherein the first port mapping list is contained in the packet forwarding control protocol session establishment request message. In one embodiment, the second message is a packet forwarding control protocol session establishment response message, wherein the second port mapping list is contained in the packet forwarding control protocol session establishment response message.

In one embodiment, a method of a user equipment comprises: communicating with a mobile communication network via a non-third generation partnership program access network and via a third generation partnership program access network; transmitting a first message requesting a multi-access data connection with the mobile communication network, wherein the first message comprises a first port mapping list, each element in the first port mapping list comprises an internal port and a suggested external port, and the first port mapping list is to be applied by a proxy function in the mobile communication network; and receiving a second message accepting the multi-access data connection, wherein the second message comprises a second port mapping list, each element in the second port mapping list comprises the internal port and an assigned external port, and the second port mapping list is applied by the proxy function in the mobile communication network.

In certain embodiments, the method further comprises receiving a connection request from the proxy function for a first internal port.

In some embodiments, the method further comprises initiating a connection with a local service after receiving the connection request, wherein the local service is determined based on the first internal port.

In various embodiments, the connection with the local service contains an internet protocol address and a port number of a remote host.

In one embodiment, the connection request from the proxy function comprises a transmission control protocol connection request packet containing a multi-path transmission control protocol capable option and includes an internet protocol address and a port number of a remote host.

In certain embodiments, the first port mapping list is included in the first message for enabling inbound connections to the user equipment via the proxy function.

In some embodiments, the first port mapping list is included in the first message in response to the user equipment being configured to provide port forwarding.

In various embodiments, the proxy function is implemented in a user-plane function of the mobile communication network, and the user-plane function terminates the multi-access data connection.

In one embodiment, the first message comprises a protocol data unit session establishment request message, and the first port mapping list is contained in the protocol data unit session establishment request message.

In certain embodiments, the second message comprises a protocol data unit session establishment accept message, and the second port mapping list is contained in a protocol data unit session establishment request message.

In one embodiment, an apparatus comprises a user equipment. The apparatus further comprises: a processor that communicates with a mobile communication network via a non-third generation partnership program access network and via a third generation partnership program access network; a transmitter that transmits a first message requesting a multi-access data connection with the mobile communication network, wherein the first message comprises a first port mapping list, each element in the first port mapping list comprises an internal port and a suggested external port, and the first port mapping list is to be applied by a proxy function in the mobile communication network; and a receiver that receives a second message accepting the multi-access data connection, wherein the second message comprises a second port mapping list, each element in the second port mapping list comprises the internal port and an assigned external port, and the second port mapping list is applied by the proxy function in the mobile communication network.

In certain embodiments, the receiver receives a connection request from the proxy function for a first internal port.

In some embodiments, the processor initiates a connection with a local service after receiving the connection request, and the local service is determined based on the first internal port.

In various embodiments, the connection with the local service contains an internet protocol address and a port number of a remote host.

In one embodiment, the connection request from the proxy function comprises a transmission control protocol connection request packet containing a multi-path transmission control protocol capable option and includes an internet protocol address and a port number of a remote host.

In certain embodiments, the first port mapping list is included in the first message for enabling inbound connections to the user equipment via the proxy function.

In some embodiments, the first port mapping list is included in the first message in response to the user equipment being configured to provide port forwarding.

In various embodiments, the proxy function is implemented in a user-plane function of the mobile communication network, and the user-plane function terminates the multi-access data connection.

In one embodiment, the first message comprises a protocol data unit session establishment request message, and the first port mapping list is contained in the protocol data unit session establishment request message.

In certain embodiments, the second message comprises a protocol data unit session establishment accept message, and the second port mapping list is contained in a protocol data unit session establishment request message.

In one embodiment, a method of a user-plane function comprises: receiving a first message from a session management function in a mobile communication network requesting a multi-access data connection with a user equipment, wherein the first message comprises a first port mapping list, each element in the first port mapping list comprises an internal port and a suggested external port, and the first port mapping list is to be applied by a proxy function in the user-plane function; and transmitting a second message accepting the multi-access data connection, wherein the second message comprises a second port mapping list, each element in the second port mapping list comprises the internal port and an assigned external port, and the second port mapping list is applied by the proxy function in the user-plane function.

In certain embodiments, the method further comprises receiving a connection request from a remote host, wherein the connection request is for an address of a user equipment and a first external port.

In some embodiments, the method further comprises using the second port mapping list to derive a first internal port mapped to the first external port.

In various embodiments, the method further comprises transmitting a connection request to the user equipment for the first internal port.

In one embodiment, the connection request comprises a transmission control protocol connection request packet containing a multi-path transmission control protocol capable option and includes an internet protocol address and a port number of the remote host.

In certain embodiments, the first port mapping list is included in the first message for enabling inbound connections to the user equipment via the user-plane function.

In some embodiments, the first port mapping list is included in the first message in response to the user equipment being configured to provide port forwarding.

In various embodiments, the first message is a packet forwarding control protocol session establishment request message, wherein the first port mapping list is contained in the packet forwarding control protocol session establishment request message.

In one embodiment, the second message is a packet forwarding control protocol session establishment response message, wherein the second port mapping list is contained in the packet forwarding control protocol session establishment response message.

In one embodiment, an apparatus comprises a user-plane function. The apparatus further comprises: a receiver that receives a first message from a session management function in a mobile communication network requesting a multi-access data connection with a user equipment, wherein the first message comprises a first port mapping list, each element in the first port mapping list comprises an internal port and a suggested external port, and the first port mapping list is to be applied by a proxy function in the user-plane function; and a transmitter that transmits a second message accepting the multi-access data connection, wherein the second message comprises a second port mapping list, each element in the second port mapping list comprises the internal port and an assigned external port, and the second port mapping list is applied by the proxy function in the user-plane function.

In certain embodiments, the receiver receives a connection request from a remote host, wherein the connection request is for an address of a user equipment and a first external port.

In some embodiments, the processor uses the second port mapping list to derive a first internal port mapped to the first external port.

In various embodiments, the transmitter transmits a connection request to the user equipment for the first internal port.

In one embodiment, the connection request comprises a transmission control protocol connection request packet containing a multi-path transmission control protocol capable option and includes an internet protocol address and a port number of the remote host.

In certain embodiments, the first port mapping list is included in the first message for enabling inbound connections to the user equipment via the user-plane function.

In some embodiments, the first port mapping list is included in the first message in response to the user equipment being configured to provide port forwarding.

In various embodiments, the first message is a packet forwarding control protocol session establishment request message, wherein the first port mapping list is contained in the packet forwarding control protocol session establishment request message.

In one embodiment, the second message is a packet forwarding control protocol session establishment response message, wherein the second port mapping list is contained in the packet forwarding control protocol session establishment response message.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An user equipment (UE), comprising:
at least one memory; and
at least one processor coupled with the at least one memory and configured to cause the UE to:
communicate with a mobile communication network via a non-third generation partnership program access network and via a third generation partnership program access network;
transmit a first message requesting a multi-access data connection with the mobile communication network, wherein the first message comprises a first port mapping list, each element in the first port mapping list comprises an internal port and a suggested external port, and the first port mapping list is to be applied by a proxy function in the mobile communication network; and
receive a second message accepting the multi-access data connection, wherein the second message comprises a second port mapping list, each element in the second port mapping list comprises the internal port and an assigned external port, and the second port mapping list is applied by the proxy function in the mobile communication network.

2. The UE of claim 1, wherein the at least one processor is configured to cause the UE to receive a connection request from the proxy function for a first internal port.

3. The UE of claim 2, wherein the at least one processor is configured to cause the UE to initiate a connection with a local service after receiving the connection request, and the local service is determined based on the first internal port.

4. The UE of claim 3, wherein the connection with the local service contains an internet protocol address and a port number of a remote host.

5. The UE of claim 2, wherein the connection request from the proxy function comprises a transmission control protocol (TCP) connection request packet containing a multi-path transmission control protocol (MPTCP) capable option and includes an internet protocol address and a port number of a remote host.

6. The UE of claim 5, wherein the first port mapping list is included in the first message for enabling inbound connections to the UE via the proxy function.

7. The UE of claim 1, wherein the first port mapping list is included in the first message in response to the UE being configured to provide port forwarding.

8. The UE of claim 7, wherein the proxy function is implemented in a user-plane function of the mobile communication network, and the user-plane function terminates the multi-access data connection.

9. The UE of claim 8, wherein the first message comprises a protocol data unit (PDU) session establishment request message, and the first port mapping list is contained in the PDU session establishment request message.

10. The UE of claim 9, wherein the second message comprises a PDU session establishment accept message, and the second port mapping list is contained in a PDU session establishment request message.

11. An apparatus for performing a network function, the apparatus further comprising:
at least one memory; and
at least one processor coupled with the at least one memory and configured to cause the apparatus to:
receive a first message from a session management function in a mobile communication network requesting a multi-access data connection with a user equipment (UE), wherein the first message comprises a first port mapping list, each element in the first port mapping list comprises an internal port and a suggested external port, and the first port mapping list is to be applied by a proxy function in the user-plane function; and
transmit a second message accepting the multi-access data connection, wherein the second message comprises a second port mapping list, each element in the second port mapping list comprises the internal port and an assigned external port, and the second port mapping list is applied by the proxy function in the user-plane function.

12. The apparatus of claim 11, wherein the at least one processor is configured to cause the apparatus to receive a connection request from a remote host, wherein the connection request is for an address of a UE and a first external port.

13. The apparatus of claim 12, wherein the at least one processor is configured to cause the apparatus to use the second port mapping list to derive a first internal port mapped to the first external port.

14. The apparatus of claim 13, wherein the at least one processor is configured to cause the apparatus to transmit a connection request to the UE for the first internal port.

15. The apparatus of claim 14, wherein the connection request comprises a transmission control protocol (TCP) connection request packet containing a multi-path transmission control protocol (MPTCP) capable option and includes an internet protocol address and a port number of the remote host.

16. A processor for wireless communication, comprising:
at least one controller coupled with at least one memory and configured to cause the processor to:
communicate with a mobile communication network via a non-third generation partnership program access network and via a third generation partnership program access network;
transmit a first message requesting a multi-access data connection with the mobile communication network, wherein the first message comprises a first port mapping list, each element in the first port mapping list comprises an internal port and a suggested external port, and the first port mapping list is to be applied by a proxy function in the mobile communication network; and
receive a second message accepting the multi-access data connection, wherein the second message comprises a second port mapping list, each element in the second port mapping list comprises the internal port and an assigned external port, and the second port mapping list is applied by the proxy function in the mobile communication network.

17. The processor of claim 16, wherein the at least one controller is configured to cause the processor to receive a connection request from the proxy function for a first internal port.

18. The processor of claim 18, wherein the at least one controller is configured to cause the processor to initiate a connection with a local service after receiving the connection request, and the local service is determined based on the first internal port.

19. The processor of claim 19, wherein the connection with the local service contains an internet protocol address and a port number of a remote host.

20. A method performed by a user equipment (UE), the method comprising:
communicating with a mobile communication network via a non-third generation partnership program access network and via a third generation partnership program access network;
transmitting a first message requesting a multi-access data connection with the mobile communication network, wherein the first message comprises a first port mapping list, each element in the first port mapping list comprises an internal port and a suggested external port, and the first port mapping list is to be applied by a proxy function in the mobile communication network; and
receiving a second message accepting the multi-access data connection, wherein the second message comprises a second port mapping list, each element in the second port mapping list comprises the internal port and an assigned external port, and the second port mapping list is applied by the proxy function in the mobile communication network.
